(19) United States
(12) Patent Application Publication
(10) Pub. No.: US 2015/0127630 A1
(43) Pub. Date: May 7, 2015

(54) SYSTEM AND METHOD FOR PROCESSING VIRTUAL INTERVIEW USING DIVISION CONTENT

(71) Applicant: COMBUSTEC CO., LTD, Seoul (KR)

(72) Inventor: Don Won LEE, Seoul (KR)

(73) Assignee: COMBUSTEC CO., LTD, Seoul (KR)

(21) Appl. No.: 14/071,675

(22) Filed: Nov. 5, 2013

(51) Int. Cl. G06F 17/30

(52) U.S. Cl. CPC G06F 17/3048
USPC 707/722

(57) ABSTRACT

A method for processing a virtual interview using division content, the method including generating a distribution inversely proportional to a usage amount of division content divided into a minimum unit to implement a virtual interview, extracting the division content in response to cache information of a user terminal, which includes content request information, transmitting combination content generated by combining the extracted division content to the user terminal, and controlling a selection probability in such a manner that the selection probability is inversely proportional to a usage amount of the extracted division content.

### BACKGROUND

1. Field of the Invention

The present invention relates to a virtual interview processing system, and more particularly, to a virtual interview processing system using division content and a method thereof, which are provided in a real-time combination of the division content for a virtual interview.

2. Discussion of Related Art

An interview related to an employment, an admission, or the like is one of processes that are as important as each related test. This is because an interviewer, and an interviewee (hereinafter, referred to as “applicant”) may identify a personality and a way of thinking, and express the personality and the way of thinking, respectively through the interview. Thus, applicants may prepare for the interview in a variety of forms.

Due to the importance of the interview, the applicants may take a lecture on the interview in a private educational institute, or practice a virtual interview.

However, such a virtual interview performed off-line has drawbacks in that the applicants cannot spend much time on a practice in various ways. After all, there are many cases that the applicants end up with a preparation of the interview vaguely through their seniors or books relating to the interview.

Thus, in order to complement these drawbacks, a proposal of providing a virtual on-line interview service has been suggested.

Since the virtual on-line interview service enables the applicants to perform the virtual interview spending much of time in various ways, the virtual on-line interview service may be of much help to the applicants.

However, when the virtual on-line interview is performed through a user terminal, a user is allowed to set an interview environment including an application field, an interview direction, and the like, and a server may perform a batch data transmission in response to the interview environment that has been usually set. In this case, when previously produced image data for the virtual interview is included in transmitted data, there may be a problem caused such that a capacity is increased.

Thus, in order to transmit massive data, a lot of system resources (for example, a large-scale server system) and a broadband communication network are needed, but when considering a network environment in which a data request from the user terminal changes on an hourly basis, securing the system resources based on maximum traffic may lead to a loss of the system resources. In addition, in a system that allows all of the users to download data so as to transmit image data, a bandwidth is needed corresponding to the number of nodes connected to the server, and a problem of delay in transmission or degradation in a quality of service (QoS) may occur.

Thus, in order to enhance a quality of download, an installation of dedicated servers or additional lines is needed, but it is not advantageous due to its high cost. In addition, the delay in the transmission may be handled in such a manner that techniques such as caching or load balancing, and traffic management are used, or a server is distributed to minimize a burden on the server using an IDC (Internet Data Center) method, and a distribution type network (for example, P2P) is used, in which the data that is concentrated on the server is distributed to user terminals and a database and network management function performed only in the server is processed through a mutual cooperation and a resource sharing between the user terminals, but these methods has difficulties in being applied to the virtual on-line interview system as they are.

### SUMMARY OF THE INVENTION

The present invention is provided to solve the problems of conventional art described above. The object of the invention is to provide a virtual interview processing system using division content and a method thereof, which divide content for a virtual interview, generate virtual interview information through a real-time combination of the division content in response to a requested virtual interview environment (cache information), and transmit the virtual interview information, so as to minimize network traffic.

According to an aspect of the present invention, there is provided a virtual interview processing system using division content including a server that provides a user terminal with division content configuring a virtual interview, which are selected and combined using cache information of the user terminal in response to content request information for a virtual interview transmitted from the user terminal.

The server may include a content storing unit storing the division content, a content searching unit extracting the division content including a distribution inversely proportional to a usage amount, from the content storing unit in response to the content request information, a content combining unit generating combination content by combining the extracted division content, and a communication unit transmitting the combination content. Here, the server may further include a cache search managing unit searching for the cache information of the user terminal, which includes the content request information, and a cache storage managing unit performing the addition or deletion of the division content extracted at the content searching unit on the basis of the capacity information of the cache information.

The user terminal may include a cache search managing unit requesting a search by transmitting the cache information including the content request information to the server, and a cache storage managing unit performing the addition or deletion of the division content transmitted from the server on the basis of the capacity information of the cache information.

According to another aspect of the present invention, there is provided a method for processing a virtual interview using division content, the method including generating a distribution inversely proportional to a usage amount of division content divided into a minimum unit to implement a virtual interview, extracting the division content in response to cache information of a user terminal, which includes content request information, transmitting combination content generated by combining the extracted division content to the user terminal, and controlling a selection probability in such a manner that the selection probability is inversely proportional to a usage amount of the extracted division content.

When specific division content is selected from the division content having the same selection probability at the beginning, the controlling of a selection probability may lower the selection probability of the specific division content to a setting value in the following virtual interview.

In addition, when specific division content is selected from the division content having the same selection probability at the beginning, the controlling of a selection probability may set the selection probability of the specific division content to zero in the following virtual interview, and then the extraction from the remaining division content other than the specific division content may be performed.

The extracting of the division content in response to cache information of a user terminal may include managing a count number for sharing of the extracted division content, performed by a cache search managing unit, requesting a search for the division content for deletion by a cache storage managing unit with respect to the division content transmitted according to the request of the division content from the cache search managing unit, searching for the division content for deletion by the cache search managing unit so as to deliver the search result to the cache storage managing unit, and deleting the division content for deletion by the cache storage managing unit.

The lowest numerical value may be assigned to the division content for deletion through normalization of the number of reading times of the division content, the last date of reading the division content, and the number of sharing times of the division content.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a configuration of a virtual interview processing system using division content according to an exemplary embodiment of the present invention;

FIG. 2 is a diagram illustrating a configuration a server according to the exemplary embodiment of the present invention;

FIG. 3 is a conceptual diagram illustrating generation of combination content according to the exemplary embodiment of the invention;

FIG. 4 is a flowchart illustrating controlling a selection probability of division content according to the exemplary embodiment;

FIG. 5 is a conceptual diagram illustrating an exemplary embodiment in which a selection probability of the division content is controlled;

FIG. 6 is a conceptual diagram illustrating another exemplary embodiment in which a selection probability of division content is controlled;

FIG. 7 is a flowchart illustrating a transfer process of the division content according to the exemplary embodiment of the present invention; and

FIG. 8 is a flowchart illustrating an exemplary embodiment in which division content for deletion is deleted.

### DETAILED DESCRIPTION OF EXEMPLARY EMBODIMENTS

First of all, while illustrating a drawing, in order to clarify the present invention, irrelevant parts to the description may be omitted, the same reference numeral can be granted for the same parts throughout the entire specification. In the entire specification, the same redundant configuration, which is repeated, may not be described. In addition, over the entire specification, when any part is “provide or provided” or “configures or configured”, as long as these do not include disclosures that are particularly opposite in the meaning, such terms mean that they include an additional different configuration elements, without excluding them.

In addition, the terms “˜part”, “-based”, which are listed in the specification, mean a unit that processes at least one of a function or operation, which may be implemented as hardware or software equipped with a storage device, or implemented by a combination of hardware and software.

Exemplary embodiments of the present invention divide a video clip to perform a virtual interview, thereafter, combine divided video clips to generate a single image in response to a requested virtual interview, thereby performing the virtual interview.

In addition, when a specific inquiry is continuously used, in order to prevent such a specific inquiry from being overused, the invention controls a selection probability of video clips so as to be inversely proportional to a usage amount, so that various types of combined interview inquiries can be controlled in a uniform manner.

Thus, the invention uses the video clips at random. However, the invention generates a distribution inversely proportional to the usage amount of all video clips such that all of the video clips can be used in a uniform manner. Accordingly, when the virtual interview inquiries continue to be extracted at random, all problems can be provided in a uniform manner.

Furthermore, when a video clip is larger than or equal to a predetermined size in a user terminal, the invention adds or deletes the video clip by considering a cache capacity, so that a transmission capacity can be controlled.

Here, cache management may, preferably, use a method of deleting the video clip in a sequence of the number of the least accessed times or the last date of access.

Naturally, when a plurality of video clips are to be deleted and information on the number of access times and information on the access date are similar to each other, a small video clip is preferably deleted in which a single piece of content thereof is less used by a plurality of user terminals.

Thus, the invention combines provided common resources to perform a virtual interview service and makes an efficient use of cache in systems, so that it is possible to reduce network traffic.

Hereinafter, the present invention will be described in detail with reference to the accompanying drawings relating to a virtual interview processing system and a method thereof.

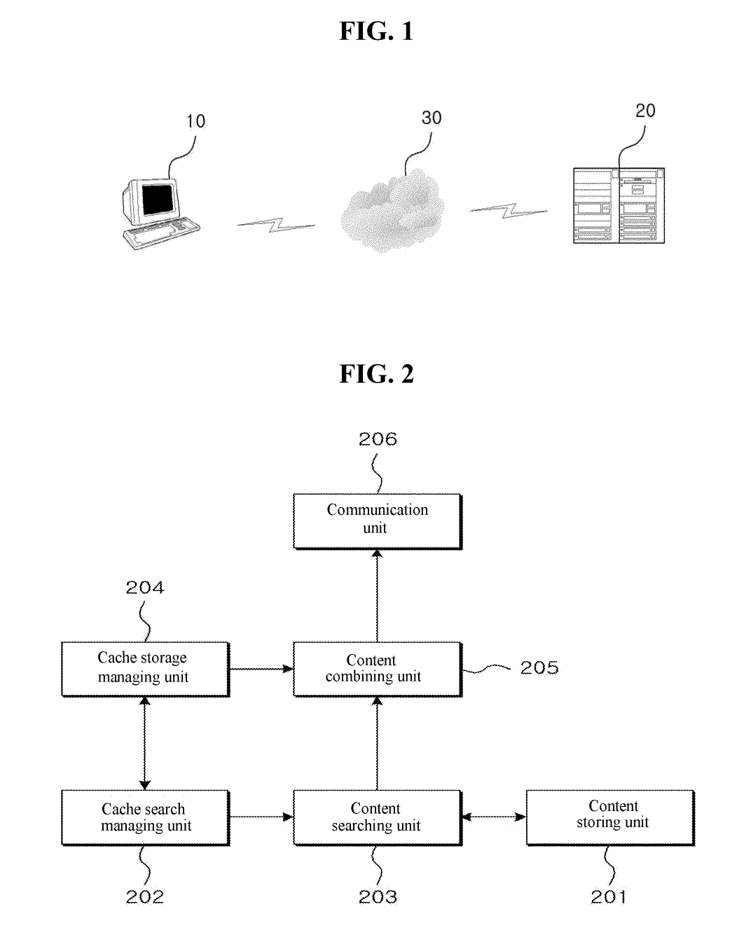

FIG. 1 is a configuration diagram of a virtual interview processing system using division content according to an exemplary embodiment of the present invention.

Referring to FIG. 1, the virtual interview processing system using division content of the invention includes a user terminal 10 requesting a virtual interview, a server 20 providing the user terminal 10 with division content configuring the virtual interview, which are selected and combined using cache information of the user terminal 10 in response to a virtual interview request, and a network 30 transmitting data for sending/receiving between the user terminal 10 and a server 20.

The present invention relates to technology for combining the division content selected in real time to generate virtual interview information in providing virtual interview information when the user terminal 10 requests the virtual interview. In this case, the server 20 selects the division content using cache information of the user terminal 10 in selecting the division content. That is, a selection probability of the division content is controlled to avoid duplication of the division content using the cache information of the user terminal 10, so that the division content can be used in a uniform manner. Then, the server 20 performs the addition or deletion of the division content depending on a capacity of the division content using the cache information of the user terminal 10, and transmits the selected division content to the user terminal 10 through the network 30.

As such, a capacity of the virtual interview information transmitted from the user terminal 10 is minimized, so that the network traffic can be reduced.

FIG. 2 is a diagram illustrating a configuration a server according to the exemplary embodiment of the present invention.

Referring to FIG. 2, the server 20 of the invention includes a content storing unit 201 storing the division content, a cache search managing unit 202 searching for cache information of the user terminal 10, which includes the content request information, a content searching unit 203 extracting the division content having a distribution inversely proportional to a usage amount from the content storing unit 201 in response to the content request information, a cache storage managing unit 204 performing the addition or deletion of the division content extracted at the content searching unit 203 on the basis of capacity information of the cache information, a content combining unit 205 combining management information delivered from the cache storage managing unit 204 and the division content output from the content searching unit 203, and a communication unit 206 transmitting combined division content.

Here, a cache manager including the cache search managing unit 202 and the cache storage managing unit 204 performs a function of providing the content when the user terminal 10 requests the content. Thus, in order to use the network 30 efficiently under the condition of a limited cache capacity, the cache manager selects the division content at random from a distribution inversely proportional to a usage amount.

In this embodiment, the server 20 is described to be configured of the cache search managing unit 202 and the cache storage managing unit 204. However, the cache search managing unit 202 and the cache storage managing unit 204 may be included as a configuration of the user terminal 10. In this case, the division content searched at the content searching unit 203 is delivered to the content combining unit 205, thereby making a combination. Then, combination content is transmitted to the user terminal 10 through the communication unit 206, and the user terminal 10 configured of the cache search managing unit 202 and the cache storage managing unit 204 may perform the function of providing the content.

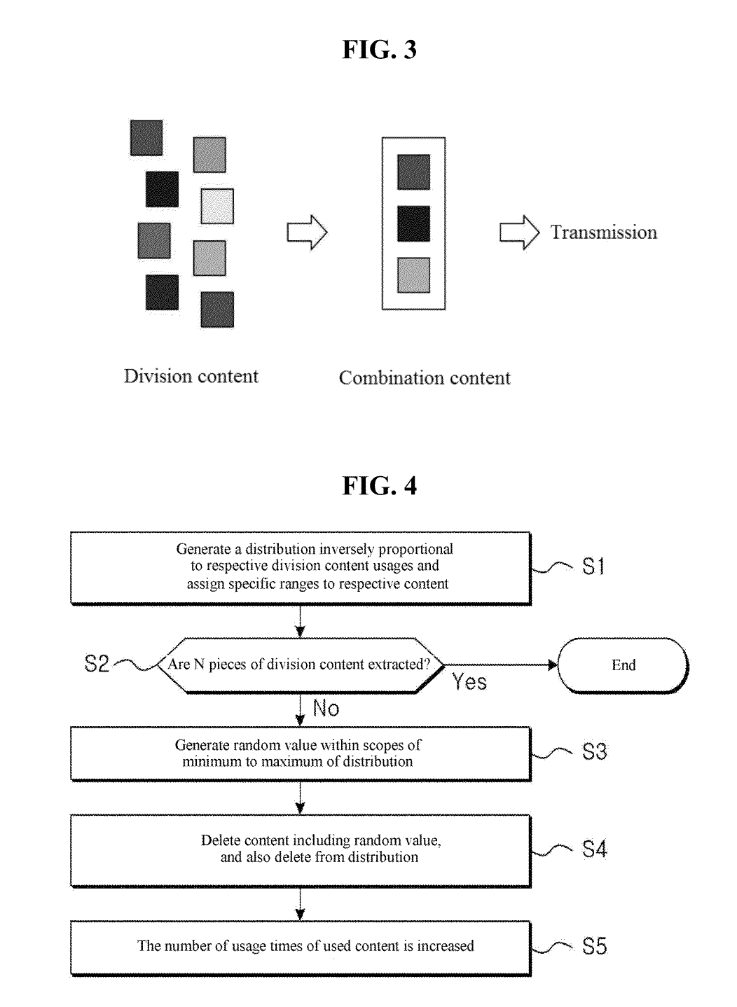

FIG. 3 is a conceptual diagram illustrating generation of combination content according to the exemplary embodiment of the invention.

Referring to FIG. 3, the content storing unit 201 stores division content divided into a minimum unit, of which selection is made at random based on cache information. Thereafter, the selected division content is combined by the content combining unit 205, and the combined division content is transmitted to the user terminal 10 through the communication unit 206.

As such, virtual interview information is generated by a combination of the division content stored in the content storing unit 201.

Here, when the content is combined, the number of times the respective division content is used is probabilistically maintained similar.

For example, when ten batteries having a limited number of charging times are assumed to be used by the four, the selection of the four batteries is made at random. However, the number of times the ten batteries are used is maintained similar to each other based on a distribution.

Thus, the invention relates to technology for increasing a probability of selecting the other batteries by reducing a probability of selecting a specific battery when the specific battery is used so as to access faster to such a distribution in a short time. That is, the distribution is generated so as to be inversely proportional to a usage amount, so that it is possible to control time of reaching the distribution to be shortened.

These techniques may be applied to a case in which three physical exercises out of ten are selected at random. Many things cannot be implemented simultaneously, accordingly, although several things divided are implemented, such techniques are suitable when a repeated work is tried continuously by adding a random element.

On the other hand, in this embodiment, the number of times the division content is selected is described. However, when such techniques are simply applied using the number of times, intensively used division content may not be used continuously. Thus, it is desirable that the techniques be operated combining other variables.

Here, a method for processing a virtual interview using division content according to the present invention, which uses configuration systems as above, will be described.

FIG. 4 is a flowchart illustrating a selection probability of division content according to the exemplary embodiment.

Referring to FIG. 4, a cache storage managing unit 204 of a cache manager generates a distribution inversely proportional to respective division content. Here, the respective content receives an assignment of specific ranges that are all the same range at the beginning (S1).

With respect to a determination of whether N pieces of division content are extracted (S2), when the N pieces of division content are not extracted, a random value is generated within a specific range (S3).

Then, content included in the random value is deleted and also deleted from a distribution (S4).

The used content is allowed to increase the number of usage times (S5), which is repeated until when the N pieces of division content are extracted.

Here, a process for managing the division content is conceptually described.

When a single packaging data is generated by combining several pieces of content, the biggest drawback of selecting the content in a simple random way is in that a specific content can be used too much and also single division content can be used continuously. On the other hand, although several pieces of division content are used too much, rather than being excluded without condition, the division content need to be generated while being appropriately used.

An embodiment of this implementation is as follows.

1. Record the number of times respective division content is used in combination content of one-dimensional array.

2. Add all the number of usage times of the respective division content, and divide respective division content by the number of the usage times.

3. Sum up resultant values of No. 2 above from bottom to top while a total sum of the resultant values of No. 2 becomes 1 (the last element value is 1).

Example) [0.1, 0.05, 0.03, 0.1, . . . , 0.05]→[0.1, 0.15, 0.18, 0.28, . . . , 1]

4. Generate a random value between 0 to 1, and use the division content at the place where the value is included.

For example, in case of a value 0.17, since it is smaller than 0.18 of the third value, the value 0.17 is used as the third division content.

On the other hand, in the embodiment described above, the more the division content is used, the bigger resultant value of No. 2 becomes, thus it is necessary to have a way to avoid this.

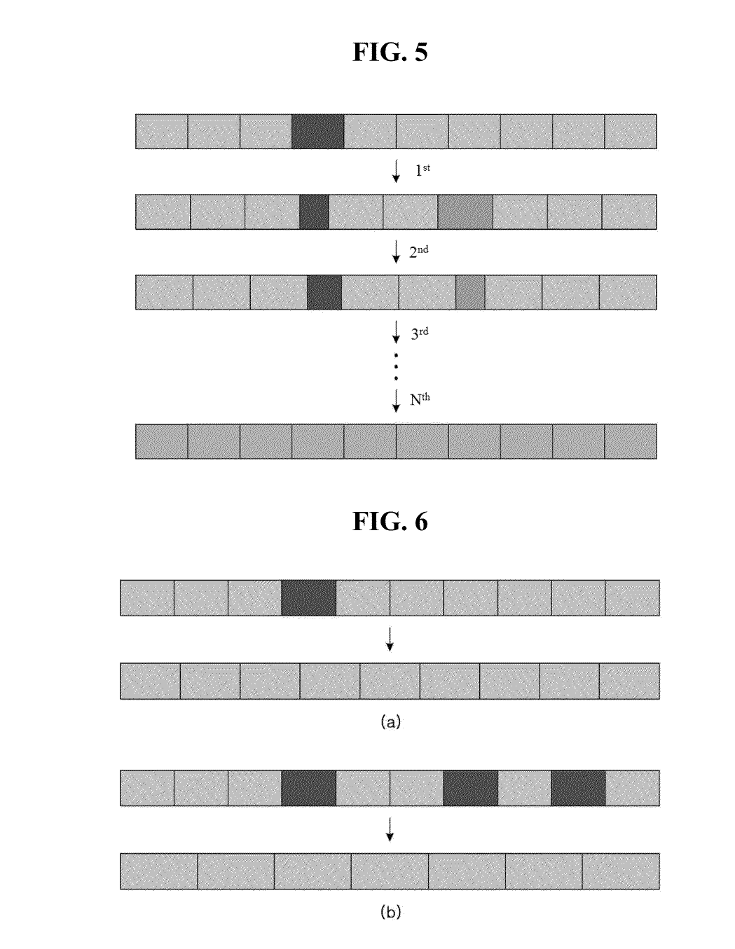

FIG. 5 is a conceptual diagram illustrating an exemplary embodiment in which a probability of the division content is controlled.

Referring to FIG. 5, in a first virtual interview, if a specific user has used division content of a red colored part. When a second virtual interview is performed, a selection probability of the first division content is set lower than that of the other division content, so that the selection probability of the other division content becomes higher.

Thereafter, in a third virtual interview, division content of the red colored part is controlled such that a selection probability becomes higher in preparation for the second virtual interview. With the repeated process of the virtual interview, in an Nth virtual interview, all division content may have almost the same probabilities.

As such, the more division content in No. 2 above are used, the less selection width it becomes, and the less selected number of times, the bigger selection width of the value is controlled, so that all division content can be maintained similar.

On the other hand, when single packaging data is generated by combining several pieces of content, there can be a problem that the same division content can be used continuously in a case of selecting content in a simple random way. However, the problem can be solved through FIG. 6.

FIG. 6 is a conceptual diagram illustrating another exemplary embodiment in which a probability of division content is controlled.

Referring to FIG. 6, since at least of one piece of the division content can be used, when specific division content configures combination content, a next virtual interview will replace a selection probability of the division content by zero obtained from the resultant values of No. 2, which are temporarily described above. As described in FIG. 6, when the fourth division content is selected in a first virtual interview, a next virtual interview will select specific division content out of nine pieces of division content from which the fourth division content has been deleted temporarily.

In this way, the division content used right before the virtual interview is deleted temporarily to control the selection probability to be zero such that the specific content can be prevented from being continuously used.

The technology may be used such a manner that random elements are applied while avoiding a repetition of the specific content, thereby allowing the division content to be used in a uniform manner.

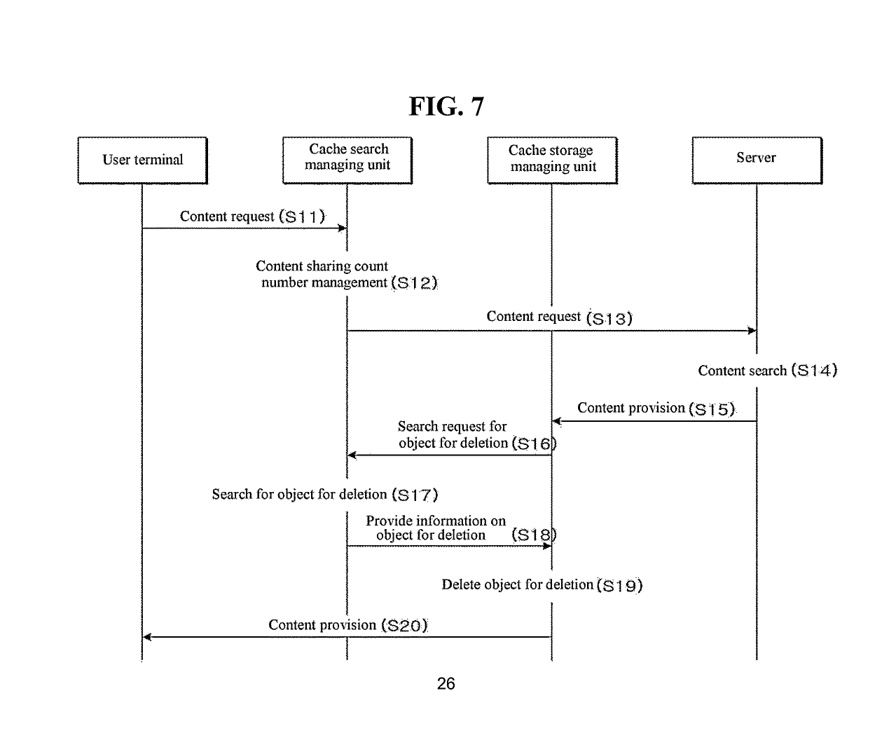

FIG. 7 is a flowchart illustrating a transfer process of the division content according to the exemplary embodiment of the present invention.

First of all, a case is described, in which a user terminal 10 is configured to include a cache search managing unit 202 and a cache storage managing unit 204.

In this embodiment, when a cache capacity is insufficient, the user terminal 10 does not include the division content, thereby having to receive the division content, which will be transmitted from a server 20.

Referring to FIG. 7, the user terminal 10 transmits an initial setting value relating to a virtual interview to the server 20 (S11).

Accordingly, the cache search managing unit 202 of the user terminal 10 checks the setting value, searches for the division content in response to the setting value, and manages a count number for sharing of the requested division content at this time.

Then, the cache search managing unit 202 requests the division content from the server 20 (S13), then the server 20 reads out the division content from the content storing unit 201 to deliver them to the cache storage managing unit 204 (S14 to S15).

The cache storage managing unit 204 requests a search for division content for deletion so as to secure the cache capacity (S16).

Then, the cache search managing unit 202 searches for the division content for deletion (S17), and delivers a search result to a cache storage managing unit 204 (S18).

The search storage managing unit 204 deletes the division content for deletion out of the division content (S19), and delivers the remaining content to the user terminal 10.

Here, when combination content is managed, the division content may be temporarily stored in a cache space of the user terminal 10, thereby reducing network traffic.

However, when the division content is deleted, it is desirable that the number of sharing times be considered together, rather than processing simply by access dates, the number of access time.

Here, a cache managing process will be described.

In the present invention, division content is combined to generate combination content so that the division content can be downloaded from a server 20, thereby providing a user with a service. On the other hand, due to a limitation of a storage capacity, the user terminal 10 stores the limited capacity of the division content using a cache, rather than storing all of the division content in his or her own storage space, and thus when the storage capacity is insufficient, the user terminal 10 secures the storage capacity by deleting from the division content of which a usage probability is the lowest depending on information.

In cache, it is very important to select priority objectives for deletion in reducing network traffic between the server 20 and the user terminal 10. Thus, as a reference for selecting the division content with the lowest usage probability out of the division content stored in the cache, the number of reading times of the division content and the last day of reading the division content may be used, furthermore, since the division content is the shared content, the number of sharing times may also be used. For example, when there is division content shared by ten pieces of combination content, and another division content shared by two pieces of combination content, the latter one becomes the priority objectives for deletion due to a lower usage probability.

Score values may be obtained by taking these three elements into consideration to select the priority objectives for deletion. Since units of the three elements are different from each other, a normalization process is to be proceeded.

$$N ( X ) = \frac{X - {X}_{min}}{{X}_{max} - {X}_{min}}$$

The score values may be adjusted by placing a weight (w) on each N (X).

Score=w_{sharing}N_{sharing}+w_{reading times}N_{reading times}+w_{access date}N_{access date}

In this manner, the priority objectives for deletion may be selected from a low score.

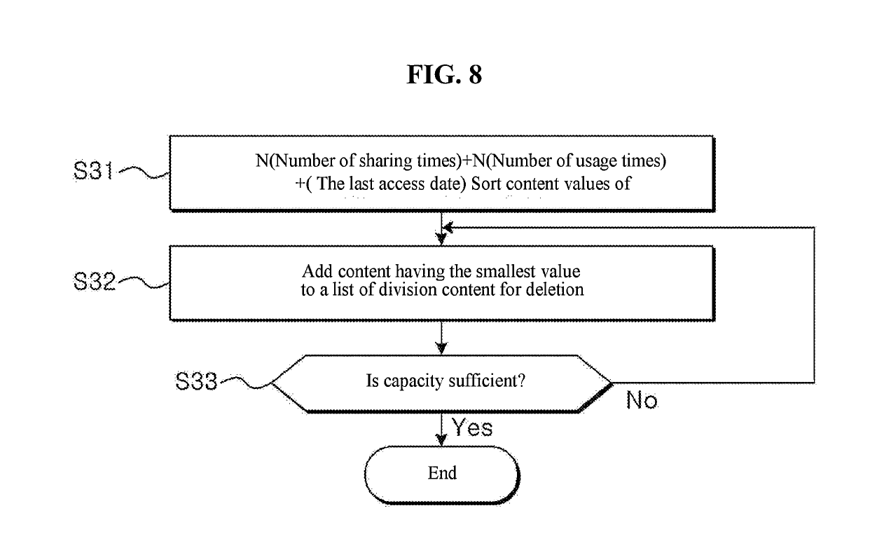

FIG. 8 is a flowchart illustrating an exemplary embodiment in which division content for deletion are deleted.

Referring to FIG. 8, a user selects combination content, and a cache manager receives a request for division content thereof.

When the cache manager determines that division content is not present, the cache manager records the sharing information and the number of sharing times of the division content and request for the division content from a server 20.

A user terminal 10 sorts the division content transmitted from the server 20 depending on a classification of the number of sharing times, usage times, recent access dates (S31). Content having the smallest capacity is added to a list of division content for deletion (S32).

Then, it is determined whether a cache capacity is sufficient (S33), when it is determined that the cache capacity is not sufficient, a score is calculated so as to select priority objective for deletion.

After the division content for deletion is deleted, the user terminal 10 stores the remaining division content in cache and informs the user of a stored location.

Here, although the usage times are small at the moment, when the number of sharing times is large, the division content may not be prioritized in a deletion request.

A value of the sharing times is divided into a fixed type in which the value of the sharing times is provided from the server 20, and a flow type in which the value of the sharing times is adjusted in the user terminal 10.

According to the present invention, since virtual interview information is combined in real time in consideration of cache information of a user terminal, network management efficiency may be enhanced. In addition, the present invention is directed to control a selection probability of division content, which is controlled to be inversely proportional to the a usage amount, and perform the addition or deletion of the division content in the consideration of a cache capacity of the user terminal, whereby various types of combined inquiries can be controlled in a uniform manner.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A virtual interview processing system using division content comprising a server that provides a user terminal with division content configuring a virtual interview, which are selected and combined using cache information of the user terminal in response to content request information for a virtual interview transmitted from the user terminal.

2. The virtual interview processing system of claim 1, wherein the server comprising:
a content storing unit storing the division content;
a content searching unit extracting the division content including a distribution inversely proportional to a usage amount, from the content storing unit in response to the content request information;
a content combining unit generating combination content by combining the extracted division content; and
a communication unit transmitting the combination content.

3. The virtual interview processing system of claim 2, wherein the server further comprising:
a cache search managing unit searching for the cache information of the user terminal, which includes the content request information; and
a cache storage managing unit performing the addition or deletion of the division content extracted at the content searching unit on the basis of the capacity information of the cache information.

4. The virtual interview processing system of claim 1, wherein the user terminal comprises:
a cache search managing unit requesting a search by transmitting the cache information including the content request information to the server; and
a cache storage managing unit performing the addition or deletion of the division content transmitted from the server on the basis of the capacity information of the cache information.

5. A method for processing a virtual interview using division content, the method comprising:
generating a distribution inversely proportional to a usage amount of division content divided into a minimum unit to implement a virtual interview;
extracting the division content in response to cache information of a user terminal, which includes content request information;
transmitting combination content generated by combining the extracted division content to the user terminal; and
controlling a selection probability in such a manner that the selection probability is inversely proportional to a usage amount of the extracted division content.

6. The method of claim 5, wherein when specific division content is selected from the division content having the same selection probability at the beginning, the controlling of a selection probability lowers the selection probability of the specific division content to a setting value in the following virtual interview.

7. The method of claim 5, wherein when specific division content is selected from the division content having the same selection probability at the beginning, the controlling of a selection probability sets the selection probability of the specific division content to zero in the following virtual interview, and then the extraction from the remaining division content other than the specific division content is performed.

8. The method of claim 5, wherein the extracting of the division content in response to cache information of a user terminal comprises:
managing a count number for sharing of the extracted division content, performed by a cache search managing unit;
requesting a search for the division content for deletion by a cache storage managing unit with respect to the division content transmitted according to the request of the division content from the cache search managing unit;
searching for the division content for deletion by the cache search managing unit so as to deliver the search result to the cache storage managing unit; and
deleting the division content for deletion by the cache storage managing unit.

9. The method of claim 8, wherein the lowest numerical value is assigned to the division content for deletion through normalization of the number of reading times of the division content, the last date of reading the division content, and the number of sharing times of the division content.
